(19) United States
(12) Patent Application Publication
(10) Pub. No.: US 2022/0305734 A1
(43) Pub. Date: Sep. 29, 2022

(54) RECOATER OPERATION ADJUSTMENTS BASED ON LAYER STRUCTURES

(71) Applicant: Hewlett-Packard Development Company, L.P., Spring, TX (US)

(72) Inventors: Daniel MOSHER, Corvallis, OR (US); Macia SOLE PONS, Sant Cugat del Valles (ES); Jeremy DONALDSON, Corvallis, OR (US)

(73) Assignee: Hewlett-Packard Development Company, L.P., Spring, TX (US)

(21) Appl. No.: 17/616,155

(22) PCT Filed: Oct. 22, 2019
(86) PCT No.: PCT/US2019/057471

§ 371 Date: Dec. 2, 2021

(51) Int. Cl. B29C 64/393; B33Y 10/00; B33Y 30/00; B33Y 50/02; B28B 1/00; B22F 10/85; B28B 17/00; B22F 12/90

(52) U.S. Cl. CPC B29C 64/393; B33Y 10/00; B33Y 30/00; B33Y 50/02; B28B 1/001; B22F 10/85; B28B 17/0081; B22F 12/90

(57) ABSTRACT

According to examples, a system may include a recoater and a controller. The controller may identify a structure of a surface of a layer of build material formed on a build platform and may determine whether the identified structure of the surface includes a portion that has a property that is outside of a predefined property level. Based on a determination that the portion has a property that is outside of the predefined property level, an adjustment to be applied to an operation of the recoater to achieve an intended structure of the layer and/or an intended structure of a subsequent layer may be determined and the determined adjustment on the operation of the recoater may be applied.

### BACKGROUND

In three-dimensional (3D) printing, an additive printing process may be used to make 3D solid parts from a digital model. Some 3D printing techniques are considered additive processes because they involve the application of successive layers or volumes of a build material, such as a powder or powder-like build material, to an existing surface (or previous layer). 3D printing often includes solidification of the build material, which for some materials may be accomplished through use of heat, a chemical binder, and/or an ultra-violet or a heat curable binder.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example system that may determine and apply an adjustment to a recoater operation based on a build material layer structure;

FIG. 2 depicts a block diagram of an example three-dimensional (3D) fabrication system that may include a controller of the example system depicted in FIG. 1;

FIGS. 3A-3C, respectively, show diagrams of example operations of the recoater; and

FIG. 4 shows a flow diagram of an example method for applying a determined adjustment on the operation of a recoater.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are systems, 3D fabrication systems, and methods for adjusting recoater operations based on a structure of a build material layer. The structure of the build material layer may denote various properties of the build material layer including, for instance, heights, densities, and/or the like across the build material layer. The structure of the build material layer may be identified from stereoscopic images of the build material layer in which the stereoscopic images may depict perceived depths across the build material layer and thus, variances across the build material layer may be determined from the stereoscopic images. In addition, or in other examples, the structure of the build material layer may be identified through implementation of other types of measurement systems, e.g., a laser height sensor, or the like.

In some examples, an operation of a recoater that may be used to form the build material layer may be adjusted to cause the build material layer to have an intended structure. For instance, the operation of the recoater may be adjusted, e.g., an operation including an additional pass of the recoater may be implemented, to cause the build material layer to have the intended structure. In addition or in other examples, an operation of the recoater that may be used to form a subsequent build material layer may be adjusted to cause the build subsequent material layer to have an intended structure.

Through implementation of the features of the present disclosure, recoater operations may be adjusted based on captured stereoscopic images of the build material layer, In this regard, the recoater operations may be adjusted through a closed loop feedback based on the structure of the build material layer as may be identified from the captured stereoscopic images of the build material layer. As a result, the build material layer and/or a subsequent build material layer may be formed to have intended structures. That is, the build material layer and/or a subsequent build material layer may have relatively uniform densities, heights, and/or the like, which may result in 3D objects being fabricated with high levels of accuracy, high levels of strength, and/or the like.

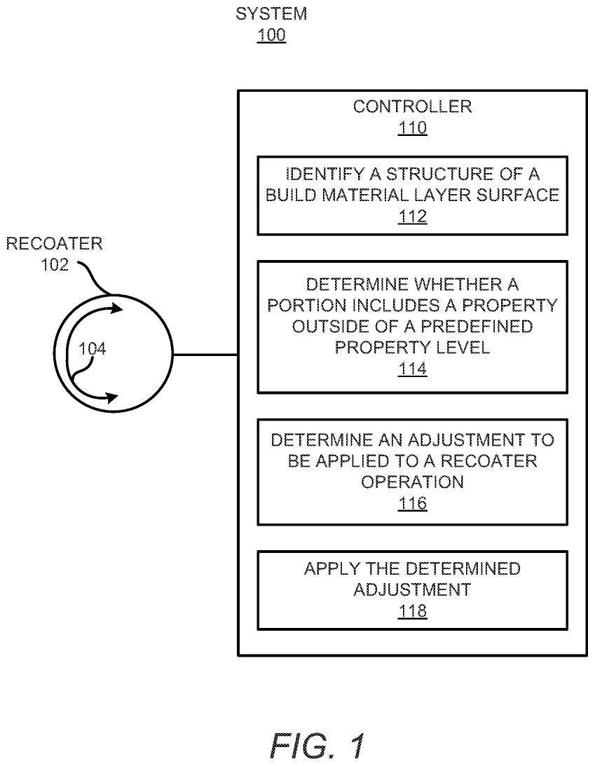

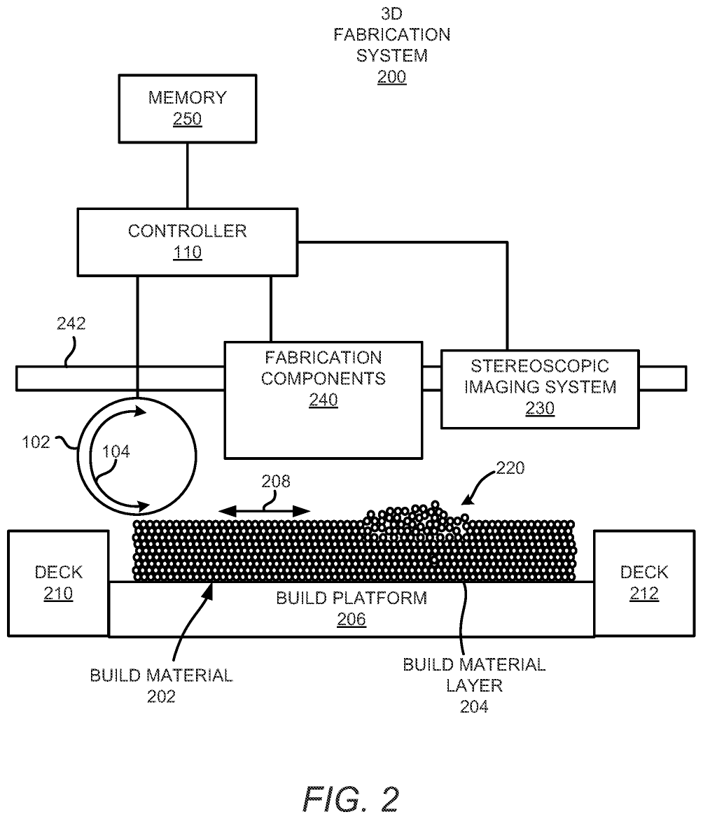

Reference is first made to FIGS. 1 and 2. FIG. 1 shows a block diagram of an example system 100 that may determine and apply an adjustment to a recoater operation based on a build material layer structure. FIG. 2 shows a block diagram of an example three-dimensional (3D) fabrication system 200 that may include a controller of the example system 100 depicted in FIG. 1. It should be understood that the example system 100 depicted in FIG. 1 and the example 3D fabrication system 200 depicted in FIG. 2 may include additional features and that some of the features described herein may be removed and/or modified without departing from the scopes of the system 100 and/or the 3D fabrication system 200.

In some examples, the system 100 may be part of the 3D fabrication system 200, e.g., a control system of the 3D fabrication system 200. The 3D fabrication system 200 may also be termed a 3D printing system, a 3D fabricator, or the like, and may be implemented to fabricate 3D objects through selective binding and/or solidifying of build material 202, which may also be termed build material particles, together. The build material 202 may be formed into a build material layer 204 on a build platform 206 during fabrication of a 3D object.

The build material 202 may include any suitable material for use in forming 3D objects. The build material 202 may include, for instance, a polymer, a plastic, a ceramic, a nylon, a metal, combinations thereof, or the like, and may be in the form of a powder or a powder-like material. Additionally, the build material 202 may be formed of particles or powder, which may have dimensions, e.g., widths, diameters, or the like, that are generally between about 5 μm and about 100 μm. In other examples, the build material particles may have dimensions that are generally between about 30 μm and about 60 μm. The particles may have any of multiple shapes, for instance, as a result of larger particles being ground into smaller particles. In some examples, the particles may be formed from, or may include, short fibers that may, for example, have been cut into short lengths from long strands or threads of material. In addition, or in other examples, the particles may be partially transparent or opaque. According to one example, a suitable build material may be PA12 build material commercially known as V1R10A “HP PA12” available from HP Inc.

As shown, the system 100 and the 3D fabrication system 200 may include a recoater 102, which may spread, deposit, or otherwise form the build material 202 into a build material layer 204. By way of example, the recoater 102 may be a roller, a spreader, a wiper blade, or the like, that may spread the build material 202 into the build material layer 204 as the recoater 102 is moved, e.g., scanned, across the build platform 206 as indicated by the arrow 208. As another example, the recoater 102 may include a sprayer, or the like, that may sprinkle the build material 202 to form the build material layer 204 as the recoater 102 is moved across the build platform 206 as indicated by the arrow 208. According to examples, the build platform 206 may provide a build area for the build material 202 to be spread into successive layers 204 of build material 202. The build platform 206 may be downwardly movable during formation of successive build material layers 204.

According to examples, the 3D fabrication system 200 may include a deck 210 from which build material 202 may be supplied for formation into build material layers 204. For instance, the deck 210 may supply an amount of build material 202 on top of the deck 210 that the recoater 102 may push over the build platform 206 as the recoater 102 is moved across the build platform 206 as denoted by the arrow 208 to form a build material layer 204 on the build platform 206 or on a previously formed build material layer 204. In some examples, the 3D fabrication system 200 may include another deck 212 from which build material 202 may be supplied for formation into build material layers 204. The 3D fabrication system 200 may include the deck 212 to enable build material layers 204 to be formed as the recoater 102 is moved in either or both of the directions denoted by the arrow 208. In other examples, however, the build material 202 may be sprayed or otherwise deposited onto or over the build platform 206.

In any of the examples discussed herein, the recoater 102 may be moved across the build platform 206 and may push the build material 202 to cause the build material layer 204 to have a smooth upper surface and/or consistent properties, e.g., density, height, and/or the like, throughout the build material layer 204. During translational movement as denoted by the arrow 208, the recoater 102 may be rotated as denoted by the arrow 104. For instance, as the recoater 102 is moved from left to right in FIG. 2, the recoater 102 may rotate in a counter-clockwise direction and as the recoater 102 is moved from right to left in FIG. 2, the recoater 102 may rotate in a clockwise direction.

In various instances, the movement of the recoater 102 over the build material layer 204 may not result in the build material layer 204 having consistent properties across the build material layer 204. For instance, the movement of the recoater 102 may result in a portion 220 (or multiple portions) of the build material layer 204 to be raised above or to be lower than other portions, a portion 220 that may have a lower or higher density than the other portions, and/or the like. As shown in FIG. 2, a portion 220 of the build material layer 204 may have a portion that has a lower density than the other portions of the build material layer 204 and may thus be raised as compared with the other portions. In other instances, the build material layer 204 have a portion that has a higher density than the other portions and may thus be lowered as compared with the other portions.

The recoater 102 may have an imperfection and/or an eccentricity that may cause the build material layer 204 to have the portion 220 that has a property that is different from other portions of the build material layer 204. That is, for instance, the recoater 102 may include an imperfection on a surface of the recoater 102 that may cause the portion 220 to be formed as the recoater 102 is moved across the build material layer 204. As another example, a support structure for the recoater 102 may include a defect that may cause the recoater 102 to apply a varied amount of pressure onto the build material layer 204 as the recoater 102 is moved across the build platform 206. Similarly, the vertical position of the recoater 102 may vary as the recoater 102 is moved across the build platform 206, In some instances, the imperfection and/or eccentricity may be created during manufacturing of the recoater 102 and/or the 3D fabrication system 200 and may thus be individualized to the recoater 102 and/or the 3D fabrication system 200. In addition, or in other instances, the imperfection and/or eccentricity may occur due to wear as the recoater 102 is implemented in the 3D fabrication system 200. In still other instances, the portion 220 may be formed due to morphology changes and/or powder size distribution changes in the build material 202 over time.

As also shown in FIGS. 1 and 2, the system 100 and the 3D fabrication system 200 may also include a controller 110. The controller 110 may be a computing system such as a server, a laptop computer, a tablet computer, a desktop computer, or the like. In other examples, the controller 110 may be a semiconductor-based microprocessor, a central processing unit (CPU), an application specific integrated circuit (ASIC), a field-programmable gate array (FPGA), and/or other suitable hardware device. In any of these examples, the controller 110 may control operations of the recoater 102 to, for instance, cause the build material layer 204 and/or another build material layer that may be formed subsequently to the build material layer 204, e.g., on top of or above the build material layer 204 to have an intended structure. In other words, the controller 110 may adjust an operation of the recoater 102 to cause the build material layer 204 and/or another build material layer to have consistent properties, e.g., heights, densities, and/or the like, across the build material layer 204 and/or another build material layer.

As shown in FIG. 1, the controller 110 may execute a number of instructions 112-118 to adjust the operation of the recoater 102. The controller 110 may be programmed to execute the instructions 112-118, e.g., the instructions 112-118 may be programmed into hardware components of the controller 110. In other examples, the system 100 may include a memory 250 (FIG. 2) that may have stored thereon machine-readable instructions (which may also be termed computer-readable instructions) that the controller 110 may execute. The memory may be an electronic, magnetic, optical, or other physical storage device that contains or stores executable instructions. The memory may be, for example, Random Access memory (RAM), an Electrically Erasable Programmable Read-Only Memory (EEPROM), a storage device, an optical disc, and the like. The memory, which may also be referred to as a computer readable storage medium, may be a non-transitory machine-readable storage medium, where the term “non-transitory” does not encompass transitory propagating signals.

The controller 110 may identify 112 a structure of a surface of a layer 204 of build material 202 (which may equivalently be recited as a build material layer 204) formed on a build platform 206. That is, for instance, the controller 110 may identify a texture, contour, shape, and/or the like of the surface of the build material layer 204. As discussed herein, the controller 110 may access a stereoscopic image of the build material layer 204 surface and may identify the structure of the build material layer 204 surface from the accessed stereoscopic image.

According to examples, the 3D fabrication system 200 may include a stereoscopic imaging system 230 that may capture the stereoscopic image of the build material layer 204. The stereoscopic imaging system 230 may include a plurality of cameras that may be positioned to capture images of the surface of the build material layer 204 from multiple angles with respect to each other. Particularly, the cameras may be positioned with respect to each other such that the captured images may be stitched or otherwise combined with each other to generate the stereoscopic image of the build material layer 204. In addition, the combined image may show perceived depths, e.g., a 3D structure, of the build material layer 204. In one regard, the cameras of the stereoscopic imaging system 230 may be of sufficiently high resolution to enable features of predefined sizes to be identified from the captured images. The predefined sizes may correspond to sizes of structures in the build material layer 204 that the controller 110 is to identify.

The controller 110 may determine 114 whether the identified structure of the surface includes a portion that has a property that is outside of a predefined property level. In other words, the controller 110 may determine whether the stereoscopic image of the build material layer 204 shows that the surface of the build material layer 204 includes any portions 220 that have a property that is outside of a predefined property level. The property may be, for instance, a height, a depth, a density, a uniformity of a density, and/or the like, and the predefined property level may be a certain difference in height, a certain difference in depth, a lack of uniformity of density, and/or the like, of the portion 220 from the height, depth, density, and/or the like, of neighboring portions.

Thus, for instance, the controller 110 may determine that the identified structure of the build material layer 204 surface includes a portion 220 that has a property that is outside of the predefined property level based on the portion 220 having a height that exceeds the height of a neighboring portion by a predefined difference level and/or percentage. Likewise, the controller 110 may determine that the identified structure includes a portion 220 that has a property that is outside of the predefined property level based on the portion 220 having a height that falls below the height of a neighboring portion by a predefined difference level and/or percentage. In addition, the controller 110 may determine that the identified structure may include a plurality of portions 220 having properties that are outside of the predefined property level.

The controller 110 may, based on a determination that the portion 220 has a property that is outside of the predefined property level, determine 116 an adjustment to be applied to an operation of the recoater 102 to achieve an intended structure of the layer 204 and/or an intended structure of a subsequent layer. According to examples, the controller 110 may determine the adjustment to be applied based on the intended structure of the build material layer 204 and/or the intended structured of a subsequent layer. In addition, the controller 110 may determine the adjustment to be applied based on prior testing, modeling, artificial intelligence, and/or the like, of various properties of build material layers 204. That is, the controller 110 may determine the adjustment based on an identification of an adjustment that may likely result in the intended structure of the layer 204 and/or an intended structure of a subsequent layer as may have been determined through prior testing, modeling, use of artificial intelligence, and/or the like.

By way of example, the intended structure of the current build material layer 204 may include a reduction or increase in the property of the portion 220 of the build material layer 204. For instance, the intended structure may be a structure in which the portion 220 of the build material layer 204 is more consistent or uniform with the neighboring portions. In this example, the adjustment to be applied to an operation of the recoater 102 may include an additional pass of the recoater 102 across the build material layer 204. The additional pass of the recoater 102 may be a pass that is in addition to originally scheduled passes of the recoater 102 to form portions of a 3D object. The originally scheduled passes may be the passes as identified in a set of instructions that the controller 110 is to execute in controlling the recoater 102 to fabricate portions of the 3D object, For instance, the instructions may cause the controller 110 to perform a single pass of the recoater 102 across the build platform 206 to form the build material layer 204 and the additional pass may be a pass that is in addition to the single pass.

During the additional pass across the build material layer 204, the adjustment to be applied to the operation of the recoater may include a modification to an attribute of the recoater. The attribute may be a rotation of the recoater 102, e.g., the recoater 102 may be rotated such that a different section of the recoater 102 may contact the portion 220, the recoater 102 may be rotated at a different speed, and/or the like. In addition, or alternatively, the attribute may be a scan speed of the recoater 102. In addition, or alternatively, the attribute of the recoater 102 may be a temperature of the recoater 102, e.g., the recoater 102 may be heated and/or certain sections of the recoater 102 may be heated prior to or during the additional pass, the recoater 102 may be heated to a different temperature, and/or like. The recoater 102 may be heated by an external heater (not shown) and/or may include internal heating elements, e.g., resistors, that may extend across the recoater 102 at multiple locations around the circumference of the recoater 102 to which a current may selectively be supplied.

In addition, or alternatively, the attribute of the recoater 102 may be a vertical position of the recoater 102, e.g., the vertical position of the recoater 102 may be modified during the additional pass such that, for instance, the recoater 102 may be moved to various vertical positions as the recoater 102 is moved across the build platform 206 during the additional pass. For instance, the controller 110 may control the recoater 102 such that the recoater 102 may be at a relatively lower level as the recoater 102 contacts the portion 220 as compared with other portions of the build material layer 204. The attribute of the recoater 102 that may be modified may include other types of attributes. For instance, the 3D fabrication system 200 may include multiple recoaters 102 having different attributes, e.g., diameters, textures, materials, and/or the like, with respect to each other and the controller 110 may adjust the attribute by lowering one of the recoaters 102 to be in position to contact the build material layer 204 and by raising the other recoaters to be out of position to contact the build material layer 204

As another example, the intended structure of a subsequent build material layer may include a structure in which the subsequent build material layer may have the same or similar portion 220. As such, for instance, the intended structure of the subsequent build material layer may be that the thickness and/or density of the subsequent build material layer may be uniform or nearly uniform across the subsequent build material layer. In this example, the adjustment to be applied to an operation of the recoater 102 may include an adjustment to the operation of the recoater 102 during a pass of the recoater 102 across the build material layer 204 to form the subsequent build material layer. Thus, for instance, the controller 110 may modify an instruction that the controller 110 is to execute in controlling the recoater 102 during formation of the subsequent build material layer.

The adjustment to be applied to the operation of the recoater may include a modification to an attribute of the recoater during formation of the subsequent build material layer. The attribute may be a rotational position of the recoater 102 as the recoater 102 is scanned across the build platform 206, e.g., the recoater 102 may be rotated such that the recoater 102 is at the same rotational position that the recoater 102 was during formation of the portion 220 in the previously formed build material layer 204. The attribute may be a rotational speed, e.g., a phase shift, and/or a translational speed of the recoater 102.

In addition, or alternatively, the attribute of the recoater 102 may be a temperature of the recoater 102. In addition, or alternatively, the attribute of the recoater 102 may be a vertical position of the recoater 102, e.g., the vertical position of the recoater 102 may be modified during the additional pass such that, for instance, the recoater 102 may be moved to various vertical positions as the recoater 102 is moved across the build platform 206 during the additional pass to match the topography of the previously formed build material layer 204. For instance, the controller 110 may control the recoater 102 such that the recoater 102 may be at a relatively higher level as the recoater 102 goes over the portion 220 as compared with other portions of the build material layer 204. The attribute of the recoater 102 that may be modified may include other types of attributes.

In addition or alternatively to the modifications to the attributes of the recoater during an additional pass across the build material layer 204 and/or during a pass to form a subsequent build material layer, the adjustment may include a movement of the build platform 206 with respect to the recoater 102. That is, for instance, instead of or in addition to movement the recoater 102 to multiple vertical positions, the build platform 206 may be moved to multiple vertical positions. By way of particular example, the build platform 206 may be moved to a position that is closer to the recoater 102 during the additional pass.

The controller 110 may apply 118 the determined adjustment on the operation of the recoater 102. Thus, for instance, the controller 110 may apply the determined adjustment during an additional pass of the recoater 102 across the build platform 206 and/or during a pass of the recoater 102 during formation of a subsequent build material layer 204.

With reference back to FIG. 2, the 3D fabrication system 200 may also include fabrication components 240 that the controller 110 may control to bind and/or fuse build material 202 at selected locations of the build material layer 204. The selected locations may be the areas of build material 202 that are to be bound together to form a part of a 3D object in the build material layer 204. The fabrication components 240 may include an agent delivery device that the controller 110 may control to deliver an agent onto the build material layer 204. For instance, the controller 110 may control the agent delivery device to deliver an agent onto the selected locations of the build material layer 204 that are to be bound/fused together.

By way of particular example, the agent delivery device may be a printhead having a plurality of nozzles in which droplet ejectors, e.g.; resistors, piezoelectric actuators, and/or the like, may be provided to eject droplets of an agent through the nozzles. In any regard, the agent delivery device may be controlled to selectively deposit the agent onto locations of the build material layer 204 at which build material 202 is to be binded together to form a portion of a 3D object. The agent delivery device may be a suitable type of agent dispenser that may controllably deposit an agent, for instance, in the form of droplets.

According to examples, the agent may be a fusing and/or a binding agent to selectively bind and/or solidify the particles of build material 202. In particular examples, the agent may be a chemical binder, a thermally curable binder, a UV curable binder, and/or the like. In other particular examples, the agent may be a fusing agent that may increase the absorption of energy to selectively fuse the particles of build material 202.

According to one example, a suitable fusing agent may be an ink-type formulation including carbon black, such as, for example, the fusing agent formulation commercially known as V1Q60A “HP fusing agent” available from HP Inc. In one example, such a fusing agent may additionally include an infra-red light absorber. In one example such fusing agent may additionally include a near infra-red light absorber. In one example, such a fusing agent may additionally include a visible light absorber. Examples of fusing agents including visible light enhancers are dye based colored ink and pigment based colored ink, such as inks commercially known as CE039A and CE042A available from HP Inc.

The fabrication components 240 may also include an energy source that may apply energy, e.g., warming energy, onto the build material layer 204, for instance, to warm the build materials 202 in the build material layer 204 to an intended temperature.

The energy source may output energy, e.g., in the form of light and/or heat and may be supported on a carriage, which may be movable across the build platform 206. As such, for instance, the energy source may output energy onto the build material layer 204 as the carriage is moved across the build platform 206 to cause the build material 202 upon which the agent has been deposited to melt and subsequently fuse together.

In addition, or alternatively, the fabrication components 240 may include an energy source, e.g., a laser beam source, that may output a laser beam to selectively heat intended locations of the build material layer 204. For instance, the fabrication components 240 may apply selective laser sintering or the like to selectively bind/fuse the build material 202 in the build material layer 204.

According to examples, the controller 110 may control movement of the fabrication components 240. That is, for instance, the controller 110 may control actuators, motors, or the like, that may control movement of the fabrication components 240 across the build platform 206. The controller 110 may also, in some examples, control the timings at which the agent delivery device may deposit the agent onto the build material layer 204 to form portions of a 3D object in the build material layer 204.

As shown, the 3D fabrication system 200 may also include a mechanism 242 along which the fabrication components 240, e.g., a carriage on which the fabrication components 240 may be supported may move across the build platform 206. The mechanism 242 may be any suitable mechanism by which and/or which may cause the carriage to be moved. For instance, the mechanism 242 may include an actuator, a belt, and/or the like that may cause the carriage to be moved.

According to examples, the controller 110 may identify 112 (FIG. 1) a structure of the surface of the build material layer 204 prior to application of an agent and/or energy onto the build material layer 204. In these examples, the controller 110 may cause the stereoscopic system 230 to capture a stereoscopic image of the build material layer 204 prior to the selective binding of the build material 202 in the layer 204, In addition, the captured stereoscopic image discussed herein may include a stereoscopic image of the layer 204 captured prior to the fabrication components selectively binding the build material 202 in the layer 204.

In other examples, the controller 110 may identify 112 a structure of the surface of the build material layer 204 following application of an agent and/or energy onto the build material layer 204. In these examples, the controller 110 may cause the stereoscopic system 230 to capture a stereoscopic image of the build material layer 204 following the selective binding of the build material 202 in the layer 204. In addition, the captured stereoscopic image discussed herein may include a stereoscopic image of the layer 204 captured following the fabrication components selectively binding the build material 202 in the layer 204.

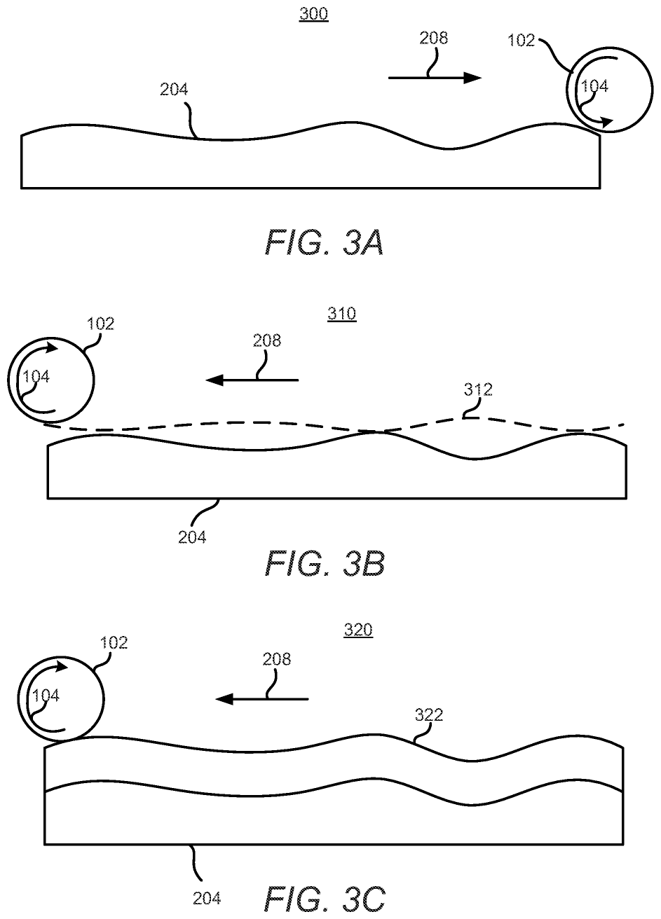

Turning now to FIGS. 3A-3C there are respectively shown diagrams 300, 310, 320 of example operations of the recoater 102. Particularly, FIG. 3A shows a diagram 300 of a build material layer 204 following movement of the recoater 102 across the build material layer 204 in the direction denoted by the arrow 208. As shown in FIG. 3A, the surface of the build material layer 204 may have undulations, which may each be equivalent to the portion 220 depicted in FIG. 2. As discussed herein, the build material layer 204 may have undulations due to imperfections and/or eccentricities in the recoater 102 and/or an actuator of the recoater 102.

FIG. 3B shows a diagram 310 which depicts the application of an adjustment of the operation of the recoater 102 during an additional pass of the recoater 102 across the build material layer 204. Particularly, FIG. 3B shows the recoater 102 being moved across the build material layer 204 in the direction denoted by the arrow 208 and rotated in the direction denoted by the arrow 104, in which the vertical position of the recoater 102 may be varied as denoted by the dotted line 312 as the recoater 102 is moved. As shown, the recoater 102 may be moved to higher vertical positions at those positions along the build material layer 204 that are lower and to lower vertical positions at those positions along the build material layer 204 that are higher. As such, for instance, the recoater 102 may better smooth out the build material layer 204 such that the build material layer 204 may have a more uniform structure across the build material layer 204. In other words, the controller 110 may control the recoater 102 to minimize the surface topography of the build material layer 204.

FIG. 3C shows a diagram 320 which depicts the application of an adjustment of the operation of the recoater 102 during a pass of the recoater 102 across the build material layer 204 to form a subsequent build material layer 322 on the build material layer 204. Particularly, FIG. 3C shows the recoater 102 being moved across the build material layer 204 in the direction denoted by the arrow 208 and rotated in the direction denoted by the arrow 104, in which the vertical position of the recoater 102 may be varied to form the subsequent build material layer 322 to have a structure that is uniform or nearly uniform with the structure of the build material layer 204. That is, for instance, the surface of the subsequent build material layer 322 may be similar to, e.g., have similar contours, have synchronized thicknesses, and/or the like, the surface of the build material layer 204.

As shown in FIG. 30, the controller 110 may control the movement of the recoater 102 such that the subsequent build material layer 322 may have structural features similar to the build material layer 204. For instance, the controller 110 may cause the recoater 102 to be moved to various vertical positions as the recoater 102 is moved across the build platform 206 to form the subsequent build material layer 204. Particularly, the recoater 102 may be moved to higher vertical positions at those positions along the subsequent build material layer 322 that are higher and to lower vertical positions at those positions along the subsequent build material layer 322 that are lower. In other examples, the controller 110 may control the rotational position of the recoater 102 such that the rotational position of the recoater 102 is the same along the translational direction of the recoater 102 for both of the passes used to form the build material layer 204 and the subsequent build material layer 322.

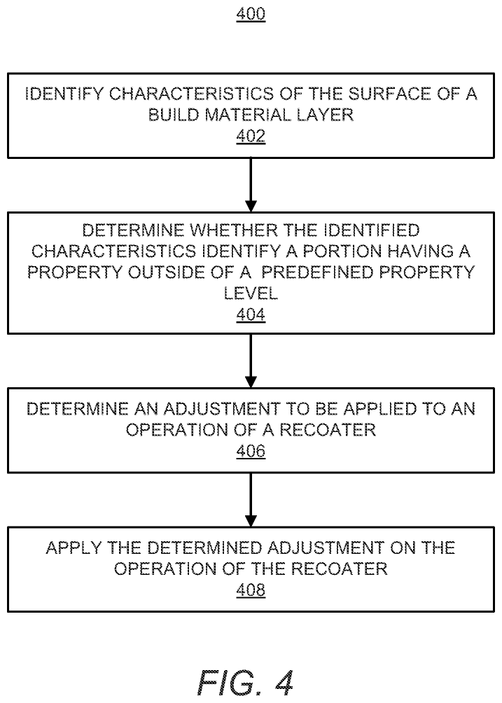

Turning now to FIG. 4, there is shown a flow diagram of an example method 400 for applying a determined adjustment on the operation of a recoater 102. It should be understood that the method 400 depicted in FIG. 4 may include additional operations and that some of the operations described therein may be removed and/or modified without departing from the scope of the method 400. The description of the method 400 is also made with reference to the features depicted in FIGS. 1-3C for purposes of illustration. Particularly, the controller 110 may execute some or all of the operations included in the method 400.

At block 402, the controller 110 may identify, from an image of a surface of a build material layer 204, characteristics of the surface of the build material layer 204. The characteristics may include, for instance, the contour or other physical feature of the surface of the build material layer 204. As discussed herein, the controller 110 may control a recoater 102 to form the build material layer 204 and may control a stereoscopic imaging system 230 to capture stereoscopic images of the build material layer 204 formed through operation of the recoater 102. In addition, the controller 110 may identify the characteristics of the surface of the build material layer 204 from the captured stereoscopic images. The controller 110 may control the stereoscopic imaging system 230 to capture images of the build material layer 204 before and/or after application of an agent and/or heat onto the build material layer 204.

At block 404, the controller 110 may determine whether the identified characteristics identify a portion 220 of the surface that has a property that is outside of a predefined property level. As discussed herein, the portion 220 of the surface may have a property, e.g., a height, density, or the like, that exceeds or falls below the predefined property level. For instance, the portion 220 may have a height that exceeds some level of deviation from the heights of neighboring portions.

At block 406, based on a determination that the identified characteristics identify a portion 220 having a property that is outside of the predefined property level, the controller 110 may determine an adjustment to be applied to an operation of a recoater 102 to achieve an intended characteristic of the build material layer 204 and/or an intended characteristic of a subsequent build material layer 322. The controller 110 may determine the adjustment to be applied to the operation of the recoater 102 in any of the manners discussed herein. As also discussed herein, the adjustment may include an additional scan of the recoater 102 on the layer 204 to further pack down the portion 220 of the layer 204, a modification to an operation of the recoater 102 during formation of a subsequent layer 322, a modification to an attribute of the recoater 102 during the additional scan and/or during formation of a subsequent layer 322, a movement of the build platform 206 with respect to the recoater 102, and/or the like.

At block 408, the controller 110 may apply the determined adjustment on the operation of the recoater 102 on the build material layer 204 and/or a subsequent build material layer 322.

Some or all of the operations set forth in the method 400 may be contained as utilities, programs, or subprograms, in any desired computer accessible medium. In addition, the method 400 may be embodied by computer programs, which may exist in a variety of forms. For example, the method 400 may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A system comprising:
a recoater; and
a controller to:
identify a structure of a surface of a layer of build material formed on a build platform;
determine whether the identified structure of the surface includes a portion that has a property that is outside of a predefined property level;
based on a determination that the portion has a property that is outside of the predefined property level, determine an adjustment to be applied to an operation of the recoater to achieve an intended structure of the layer and/or an intended structure of a subsequent layer; and
apply the determined adjustment on the operation of the recoater.

2. The system of claim 1, wherein the controller is further to:
access a stereoscopic image of the surface of the layer; and
identify the structure of the surface from the accessed stereoscopic image.

3. The system of claim 1, wherein the property comprises a height of the portion with respect to other portions of the layer, a density of the portion, and/or a uniformity of a density of the portion with respect to other portions of the layer.

4. The system of claim 1, wherein the controller is to:
identify the structure of the surface of the layer prior to and/or following application of a selective joining operation on the build material in the layer.

5. The system of claim 1, wherein the controller is further to:
determine the adjustment to be applied to the operation of the recoater to include:
an additional scan of the recoater on the layer to further pack down the portion of the layer;
a modification to an operation of the recoater during formation of a subsequent layer;
a modification to an attribute of the recoater during the additional scan and/or during formation of a subsequent layer; and/or
a movement of the build platform with respect to the recoater.

6. The system of claim 1, wherein the controller is further to:
control the recoater to move across the build platform to form a layer of build material on the build platform; and
apply the determined adjustment through control of the operation of the recoater on the layer and/or the subsequent layer based on the determined adjustment.

7. The system of claim 1, further comprising:
fabrication components; and
wherein the controller is further to:
control the fabrication components to selectively join the build material in the layer;
identify the structure of the surface following the selective joining of the build material;
determine whether the identified structure of the surface following the selective joining of the build material includes the portion having the property that is outside of the predefined property; and
based on a determination that the portion of the identified structure of the surface following the selective joining include the portion having the property that is outside of the predefined property, determine the adjustment to be applied.

8. The system of claim 1, wherein the recoater is movable vertically with respect to the build platform and is also rotatable, and wherein the adjustment on the operation of the recoater comprises an adjustment to a vertical position of the recoater with respect to the build platform as the recoater is scanned across the build platform, a timing and/or speed at which the recoater is rotated as the recoater is scanned across the build platform, and/or temperatures at multiple locations of the recoater during scanning of the recoater across the build platform.

9. A three-dimensional (3D) printing system comprising:
a recoater to form a layer of build material;
a stereoscopic imaging system to capture a stereoscopic image of the layer;
a controller; and
a memory on which is stored machine-readable instructions that when executed by the controller, cause the controller to:
determine, from the captured stereoscopic image, whether a portion of the layer has a property that is outside of a predefined property level;
determine, based on the portion of the layer having the property that is outside of the predefined property level, an adjustment to be applied to an operation of the recoater to achieve an intended structure of the layer and/or an intended structure of a subsequent layer to be formed above the layer; and
control the recoater to operate with the determined adjustment.

10. The 3D printing system of claim 9, further comprising:
fabrication components to selectively bind the build material in the layer; and
wherein the instructions are further to cause the controller to:
cause the stereoscopic imaging system to capture the stereoscopic image of the layer prior to the fabrication selectively binding the build material in the layer; and
wherein the captured stereoscopic image comprises the stereoscopic image of the layer captured prior to the fabrication selectively binding the build material in the layer.

11. The 3D printing system of claim 9, further comprising:
fabrication components to selectively bind the build material in the layer; and
wherein the instructions are further to cause the controller to:
cause the stereoscopic imaging system to capture the stereoscopic image of the layer following the fabrication components selectively binding of the build material in the layer; and
wherein the captured stereoscopic image comprises the stereoscopic image of the layer captured following the fabrication components selectively binding the build material in the layer.

12. The 3D printing system of claim 9, wherein the instructions are further to cause the controller to:
determine the adjustment to be applied to the operation of the recoater to include:
an additional scan of the recoater on the layer to further pack down the portion of the layer;
a modification to an operation of the recoater during formation of a subsequent layer;
a modification to an attribute of the recoater during the additional scan and/or during formation of a subsequent layer; and/or
a movement of the build platform with respect to the recoater.

13. A method comprising:
identifying, by a controller and from an image of a surface of a build material layer, characteristics of the surface of the build material layer;
determining, by the controller, whether the identified characteristics identify a portion of the surface that has a property that is outside of a predefined property level;
based on a determination that the identified characteristics identify a portion having a property that is outside of the predefined property level, determining, by the controller, an adjustment to be applied to an operation of a recoater to achieve an intended characteristic of the build material layer and/or an intended characteristic of a subsequent build material layer; and
applying, by the controller, the determined adjustment on the operation of the recoater on the build material layer and/or a subsequent build material layer.

14. The method of claim 13, further comprising:
controlling the recoater to form the build material layer;
controlling a stereoscopic imaging system to capture stereoscopic images of the build material layer formed through operation of the recoater; and
identifying the characteristics of the surface of the build material layer from the captured stereoscopic images.

15. The method of claim 13, wherein determining the adjustment comprises determining the adjustment to be applied to the operation of the recoater to include:
an additional scan of the recoater on the layer to further pack down the portion of the layer;
a modification to an operation of the recoater during formation of a subsequent layer;
a modification to an attribute of the recoater during the additional scan and/or during formation of a subsequent layer; and/or
a movement of the build platform with respect to the recoater.
